(19) United States
(12) Patent Application Publication
(10) Pub. No.: US 2010/0074340 A1
(43) Pub. Date: Mar. 25, 2010

(54) METHODS AND APPARATUS FOR VIDEO STREAM SPLICING

(75) Inventors: Jiancong Luo, Plainsboro, NJ (US); Li Hua Zhu, Beijing (CN); Peng Yin, West Windsor, NJ (US); Cristina Gomila, Princeton, NJ (US)

Correspondence Address: Robert D. Shedd, Patent Operations;THOMSON Licensing LLC, P.O. Box 5312, Princeton, NJ, 08543-5312, US

(73) Assignee: Thomson Licensing

(21) Appl. No.: 12/448,748

(22) PCT Filed: Jan. 7, 2008
(86) PCT No.: PCT/US2008/000187

§ 371 Date: Nov. 9, 2009

Related U.S. Application Data
(60) Provisional application No. 60/883,852, filed on Jan. 8, 2007.

(51) Int. Cl. H04N 11/02

(52) U.S. Cl. 375/240.25; 375/E07.027

(57) ABSTRACT

There are provided methods and apparatus for video stream splicing. An apparatus includes a spliced video stream generator for creating a spliced video stream using hypothetical reference decoder parameters. Another apparatus includes a spliced video stream generator for creating a spliced video stream that prevents decoder buffer overflow and underflow conditions relating to the spliced video stream by modifying standard values of at least one hypothetical reference decoder related high level syntax element.

### CROSS-REFERENCE TO RELATED APPLICATIONS

This application claims the benefit of U.S. Provisional Application Ser. No. 60/883,852, filed Jan. 8, 2007, which is incorporated by reference herein in its entirety.

### TECHNICAL FIELD

The present principles relate generally to video encoding and decoding and, more particularly, to methods and apparatus for video stream splicing.

### BACKGROUND

Video stream splicing is a frequently used procedure. The typical applications of stream splicing include, for example, video editing, parallel encoding and advertisement insertion, and so forth.

Since a compressed video stream is often transmitted through channels, the bit-rate variations need to be smoothed using buffering mechanisms at the encoder and decoder. The sizes of the physical buffers are finite and, hence, the encoder should constrain the bit-rate variations to fit within the buffer limitations. Video coding standards do not mandate specific encoder or decoder buffering mechanisms, but do specify that encoders control bit-rate fluctuations so that a hypothetical reference decoder (HRD) of a given buffer size would decode the video bit stream without suffering from buffer overflow or underflow. The hypothetical reference decoder is based on an idealized decoder model.

The purpose of a hypothetical reference decoder is to place basic buffering constraints on the variations in bit-rate over time in a coded stream. These constraints in turn enable higher layers to multiplex the stream and cost-effective decoders to decode the stream in real-time. Hypothetical Reference Decoder conformance is a normative part of the International Organization for Standardization/International Electrotechnical Commission (ISO/IEC) Moving Picture Experts Group-4 (MPEG-4) Part 10 Advanced Video Coding (AVC) standard/International Telecommunication Union, Telecommunication Sector (ITU-T) H.264 recommendation (hereinafter the “MPEG-4 AVC standard”) and, hence, any source MPEG-4 AVC Standard compliant stream inherently meets the hypothetical reference decoder requirement.

One of the major challenges of splicing a video stream compliant with the MPEG-4 AVC Standard (hereinafter “MPEG-4 AVC Standard stream”) is to ensure that a stream spliced with two independent source streams still meets the hypothetical reference decoder requirement, as defined by the MPEG-4 AVC standard. However, using the current specification, there is no guarantee that the stream combined by source streams which are already HRD-compliant is still going to be HRD-compliant. Therefore, splicing a MPEG-4 AVC Standard stream is not simply a cut-and-paste operation.

The hypothetical reference decoder is specified in the MPEG-4 AVC Standard. As defined therein, the hypothetical reference decoder model prevents an MPEG-4 AVC stream that has been encoded sequentially to cause buffer overflows or underflows at the decoder. However, we have identified three issues in the current hypothetical reference decoder model that prevent a spliced stream from being hypothetical reference decoder compliant. These issues are:
1. Incorrect time of removal from the coded picture buffer of the first picture after the concatenation point.
2. Incorrect picture output timing when concatenated with source streams with different initial decoded picture buffer delay.
3. Violation of Equations C-15 and C-16, which may lead to buffer underflow or overflow.

Therefore, in accordance with the present principles, the methods and apparatus provided herein solve at least the above deficiencies of the prior art to ensure the spliced stream is hypothetical reference decoder compliant.

Some terms and corresponding definitions thereof relating to the present principles will now be provided.

t_{r,n}(n): nominal removal time of access unit n, the nominal time to remove access unit n from the coded picture buffer (CPB).
tᵣ(n): actual removal time of access unit n, the actual time to remove access unit n from the coded picture buffer and decode instantaneously.
tₐᵢ(n): initial arrival time of access unit n, the time at which the first bit of access unit n begins to enter the coded picture buffer.
t_{af}(n): final arrival time of access unit n, the time at which the last bit of access unit n enters the coded picture buffer.
t_{o,dpb}(n): decoded picture buffer (DPB) output time, the time access unit n is output from the decoded picture buffer.
num_units_in_tick is a syntax element in a Sequence Parameter Set specifying the number of time units of a clock operating at the frequency time_scale Hz that corresponds to one increment (called a clock tick) of a clock tick counter. num_units_in_tick shall be greater than 0. A clock tick is the minimum interval of time that can be represented in the coded data. For example, when the clock frequency of a video signal is 60000÷1001 Hz, time_scale may be equal to 60 000 and num_units_in_tick may be equal to 1001.
time_scale is the number of time units that pass in one second. For example, a time coordinate system that measures time using a 27 MHz clock has a time_scale of 27000000. time_scale shall be greater than 0.
Picture timing SEI message: a syntax structure that stores the picture timing information, such as cpb_removal_delay, dpb_output_delay.
Buffering period SEI message: a syntax structure that stores the buffering period information, such as initial_cpb_removal_delay.
Buffering period: the set of access units between two instances of the buffering period supplemental enhancement information message in decoding order.
SchedSelldx: the index indicating which set of hypothetical reference decoder parameters (transmission rate, buffer size, and initial buffer fullness) is selected. A bitstream can be compliant with multiple sets of hypothetical reference decoder parameters.
Incorrect Value of cpb_removal_delay at Splicing Point

In the current hypothetical reference decoder requirements, cpb_removal_delay specifies how many clock ticks to wait after removal from the coded picture buffer of the access unit associated with the most recent buffering period supplemental enhancement information message before removing from the buffer the access unit data associated with the picture timing supplemental enhancement information message. The nominal removal time of an access unit n from the coded picture buffer is specified by the following:

t_{r,n}(n)=t_{r,n}(n_{b})+t_{c}*cpb_removal_delay(n) (C-8)

where the variable t_{c} is derived as follows and is called a clock tick.

t_{c}=num_units_in_tick*time_scale (C-1)

For the first access unit of a buffering period, t_{r,n}(n_{b}) is the nominal removal time of the first access unit of the previous buffering period, which means it requires knowledge of the length of the previous buffering period in order to correctly set cpb_removal_delay in the picture timing supplemental enhancement information message. When the source streams are independently encoded, simple concatenation of source streams will create problematic coded picture buffer removal timing. An example is shown in FIG. 1.

Turning to FIG. 1, an exemplary problematic decoding timing scenario caused by incorrect cpb_removal_delay is indicated generally by the reference numeral 100.

In the scenario of FIG. 1, we extract segment A from source stream 1 and segment D from source stream 2. Each of stream 1 and stream 2 are independently HRD compliant streams. Segment A and segment D are concatenated to form a new stream. Assume each of the segments has only one buffering period starting from the beginning of the segment. In the spliced stream, the nominal removal time of the first access unit of segment D is problematic, since it is derived from the nominal removal time of the first access unit in segment A in combination with a cpb_removal_delay derived from the length of segment C.

Mismatched Initial dpb_output_delay

In the current version of the MPEG-4 AVC Standard, the picture output timing from the decoded picture buffer is defined as follow.

The decoded picture buffer output time of picture n is derived from the following:

t_{o,dpb}(n)=tᵣ(n)+t_{c}*dpb_output_delay(n) (C-12)

where dpb_output_delay specifies how many clock ticks to wait after removal of an access unit from the coded picture buffer before the decoded picture can be output from the decoded picture buffer.

The dpb_output_delay of the first access unit of a stream is the initial dpb_output_delay. A minimum initial dpb_output_delay is used to ensure the causal relation of decoding and output. The minimum requirement of initial dpb_output_delay is depended on the picture re-ordering relationship in the whole sequence.

As an example, for a sequence encoded with GOP type IIIII . . . , the minimum requirement of initial dpb_output_delay is 0 frames, as shown in FIG. 2. Turning to FIG. 2, the relationship between exemplary decode timing and display timing of a stream A is indicated generally by the reference numeral 200. In particular, the decode timing is indicated by the reference numeral 210 and the displaying timing is indicated by the reference numeral 220.

It is to be appreciated that in FIGS. 206, solid, unlined hatching indicates an I picture, diagonal line hatching indicates a P picture, and horizontal line hatching indicates a B picture.

As another example, for a sequence encoded with GOP type IbPbP . . . , it requires a minimum 1 frame initial dpb output delay, as shown in FIG. 3. Turning to FIG. 3, the relationship between exemplary decode timing and display timing of a stream B is indicated generally by the reference numeral 300. In particular, the decode timing is indicated by the reference numeral 310 and the displaying timing is indicated by the reference numeral 320.

In stream splicing, the initial dpb_output_delay of all the source streams has to be identical. Otherwise, mismatch of initial dpb_output_delay will cause output timing problems such as, for example, either two frames being output at the same time (overlap) or extra gaps being inserted between frames.

Turning to FIG. 4, the relationship between exemplary decode timing and display timing of a concatenation of a stream A and a stream B is indicated generally by the reference numeral 400. In particular, the decode timing is indicated by the reference numeral 410 and the displaying timing is indicated by the reference numeral 420.

Turning to FIG. 5, the relationship between exemplary decode timing and display timing of another concatenation of a stream B and a stream A is indicated generally by the reference numeral 500. In particular, the decode timing is indicated by the reference numeral 510 and the displaying timing is indicated by the reference numeral 520.

FIGS. 4 and 5 illustrate the output timing problem with mismatched values of initial dpb_output_delay.

To satisfy the causal relationship, the values of initial dpb_output_delay of all the source streams have to be identical and no less than the maximum initial dpb_output_delay for all the source streams, as shown in FIG. 6.

Turning to FIG. 6, the relationship between exemplary decode timing and display timing for all source streams having identical values of initial dpb_output_delay no less than the maximum initial dpb_output delay is indicated generally by the reference numeral 600. In particular, the decode timing is indicated by the reference numeral 610 and the displaying timing is indicated by the reference numeral 620.

### Violation of Equation C-15/C-16

The current hypothetical reference decoder sets constraints to the initial_cpb_removal_delay in a buffering period supplemental enhancement information message as follows.

For each access unit n, with n>0, associated with a buffering period SEI message, with Δt_{g,90}(n) specified by

Δt_{g,90}(n)=90000*(t_{r,n}(n)−t_{af}(n−1)) (C-14)

If cbr_flag[SchedSelldx] is equal to 0,

initial_cpb_removal_delay[SchedSelldx]<=Ceil(Δt_{g,90}(n)) (C-15)

Otherwise (cbr_flag[SchedSelldx] is equal to 1),

Floor(Δt_{g,90}(n))<=initial_cpb_removal_delay[SchedSelldx]<=Ceil(Δt_{g,90(}n)) (C-16)

When the source streams are independently encoded, the spliced stream may violate these conditions easily, since the constraint (Δt_{g,90}(n)) imposed to the initial_cpb_removal_delay of the later source stream is changed. Turning to FIG. 7, an example of spliced video violating the initial_cpb_removal_delay constraint is indicated generally by the reference numeral 700. In particular, a first source stream is indicated by the reference numeral 710, and a second source stream is indicated by the reference numeral 720.

In previous video coding standards such as, for example, the International Organization for Standardization/International Electrotechnical Commission (ISO/IEC) Moving Picture Experts Group-2 standard (hereinafter the “MPEG-2 AVC standard”), stream splicing is not a challenge since the behavior of the MPEG-2 Video Buffer Verifier, a similar concept to the hypothetical reference decoder in the MPEG-4 AVC Standard, differs in implementation and ultimately in end result from the hypothetical reference decoder in the MPEG-4 AVC Standard. The problems caused by the HRD behavior in regards to the MPEG-4 AVC Standard are not present in video implementations relating to the MPEG-2 Standard due to the following reasons:
1. The decoding time of a picture is derived by the previous picture's type and, therefore, the decoding time has no problems with simple concatenation.
2. There is no requirement on the picture output timing.
3. There are no limits for the initial_cpb_removal_delay. The initial buffer fullness is based on the vbv_delay which is sent with each picture. The buffer underflow or overflow can be prevented by inserting zero stuffing bits or extra waiting time.

A MPEG-2 elementary stream can also be packed into a transport stream (TS) for transmission. The Society of Motion Picture and Television Engineers (SMPTE) standardized the splicing for MPEG-2 transport streams. The basic idea is to define constraints for MPEG-2 transport streams that enable them to be spliced without modifying the payload of the packetized elementary stream (PES) packets included therein.

However, no solution for MPEG-4 AVC stream splicing exists to overcome the above-described problems associated therewith.

### SUMMARY

These and other drawbacks and disadvantages of the prior art are addressed by the present principles, which are directed to methods and apparatus for video stream splicing.

According to an aspect of the present principles, there is provided an apparatus. The apparatus includes a spliced video stream generator for creating a spliced video stream using hypothetical reference decoder parameters.

According to another aspect of the present principles, there is provided an apparatus. The apparatus includes a spliced video stream generator for creating a spliced video stream that prevents decoder buffer overflow and underflow conditions relating to the spliced video stream by modifying standard values of at least one hypothetical reference decoder related high level syntax element.

According to yet another aspect of the present principles, there is provided a method. The method includes creating a spliced video stream using hypothetical reference decoder parameters.

According to still another aspect of the present principles, there is provided a method. The method includes creating a spliced video stream that prevents decoder buffer overflow and underflow conditions relating to the spliced video stream by modifying standard values of at least one hypothetical reference decoder related high level syntax element.

According to a further aspect of the present principles, there is provided an apparatus. The apparatus includes a spliced video stream generator for receiving hypothetical reference decoder parameters for a spliced video stream and for reproducing the spliced video stream using the hypothetical reference decoder parameters.

According to a still further aspect of the present principles, there is provided an apparatus. The apparatus includes a spliced video stream generator for receiving modified standard values of at least one hypothetical reference decoder related high level syntax element corresponding to a spliced video stream and for reproducing the spliced video stream while preventing decoder buffer overflow and underflow conditions relating to the spliced video stream using the modified standard values of at least one hypothetical reference decoder related high level syntax element.

According to a yet further aspect of the present principles, there is provided a method. The method includes receiving hypothetical reference decoder parameters for a spliced video stream. The method further includes reproducing the spliced video stream using the hypothetical reference decoder parameters.

According to an additional aspect of the present principles, there is provided a method. The method includes receiving modified standard values of at least one hypothetical reference decoder related high level syntax element corresponding to a spliced video stream. The method further includes reproducing the spliced video stream while preventing decoder buffer overflow and underflow conditions relating to the spliced video stream using the modified standard values of at least one hypothetical reference decoder related high level syntax element.

These and other aspects, features and advantages of the present principles will become apparent from the following detailed description of exemplary embodiments, which is to be read in connection with the accompanying drawings.

### BRIEF DESCRIPTION OF THE DRAWINGS

The present principles may be better understood in accordance with the following exemplary figures, in which:

FIG. 1 is a diagram showing an exemplary problematic decoding timing scenario caused by incorrect cpb_removal_delay, in accordance with the prior art;

FIG. 2 is a diagram showing the relationship between exemplary decode timing and display timing of a stream A, in accordance with the prior art;

FIG. 3 is a diagram showing the relationship between exemplary decode timing and display timing of a stream B, in accordance with the prior art;

FIG. 4 is a diagram showing the relationship between exemplary decode timing and display timing of a concatenation of a stream A and a stream B, in accordance with the prior art;

FIG. 5 is a diagram showing the relationship between exemplary decode timing and display timing of another concatenation of a stream B and a stream A, in accordance with the prior art;

FIG. 6 is a diagram showing the relationship between exemplary decode timing and display timing for all source streams having identical values of initial dpb_output_delay no less than the maximum initial dpb_output delay, in accordance with the prior art;

FIG. 7 is a diagram showing an example of spliced video violating the initial_cpb_removal_delay constraint, in accordance with the prior art;

FIG. 8 is a block diagram for an exemplary video encoder to which the present principles may be applied, in accordance with an embodiment of the present principles;

FIG. 9 is a block diagram for an exemplary video decoder to which the present principles may be applied, in accordance with an embodiment of the present principles;

FIG. 10 is a block diagram for an exemplary HRD conformance verifier, in accordance with an embodiment of the present principles;

FIG. 11A is a flow diagram for an exemplary method for inserting a splicing Supplemental Enhancement Information (SEI) message, in accordance with an embodiment of the present principles;

FIG. 11B is a flow diagram for another exemplary method for inserting a splicing Supplemental Enhancement Information (SEI) message, in accordance with an embodiment of the present principles;

FIG. 12 is a flow diagram for an exemplary method for decoding a splicing Supplemental Enhancement Information (SEI) message, in accordance with an embodiment of the present principles;

FIG. 13 is a flow diagram for an exemplary method for deriving the normal removal time t_{r,n}(n), in accordance with an embodiment of the present principles;

FIG. 14A is a flow diagram for an exemplary method for deriving the decoded picture buffer (DPB) output time t_{o,dpb}(n), in accordance with an embodiment of the present principles;

FIG. 14B is a flow diagram for another exemplary method for deriving the decoded picture buffer (DPB) output time t_{o,dpb}(n), in accordance with an embodiment of the present principles;

FIG. 15A is a flow diagram for yet another exemplary method for inserting a Supplemental Enhancement Information (SEI) message, in accordance with an embodiment of the present principles; and

FIG. 15B is a flow diagram for another exemplary method for decoding a Supplemental Enhancement Information (SEI) message, in accordance with an embodiment of the present principles.

FIG. 16 is a block diagram for an exemplary splice stream generator, in accordance with an embodiment of the present principles;

FIG. 17 is a flow diagram for an exemplary method for creating a spliced video stream, in accordance with an embodiment of the present principles;

FIG. 18 is a flow diagram for an exemplary method for reproducing a spliced video stream, in accordance with an embodiment of the present principles;

FIG. 19 is a flow diagram for another exemplary method for creating a spliced video stream, in accordance with an embodiment of the present principles; and

FIG. 20 is a flow diagram for another exemplary method for reproducing a spliced video stream, in accordance with an embodiment of the present principles.

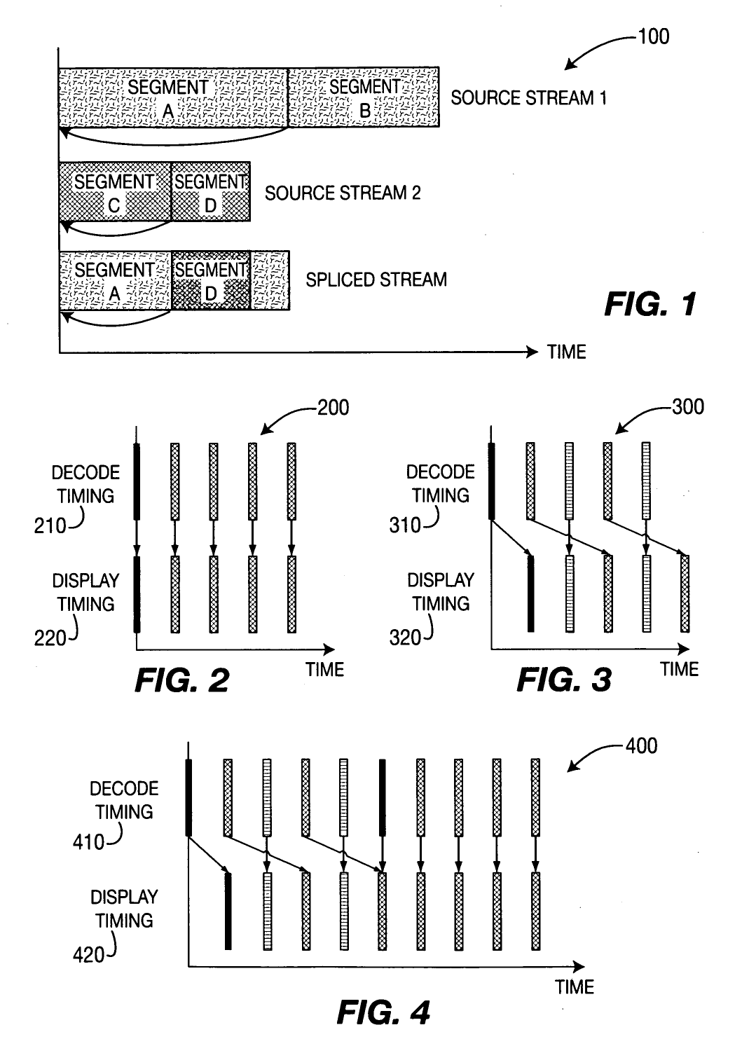

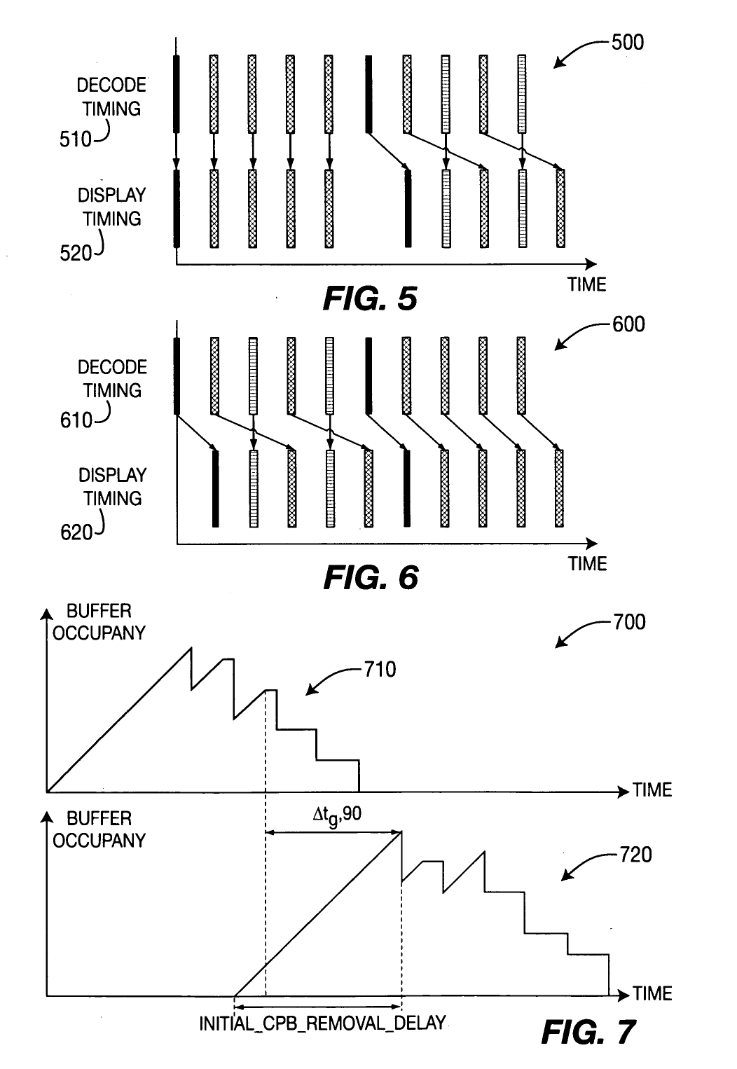

### DETAILED DESCRIPTION

The present principles are directed to methods and apparatus for video stream splicing.

The present description illustrates the present principles. It will thus be appreciated that those skilled in the art will be able to devise various arrangements that, although not explicitly described or shown herein, embody the present principles and are included within its spirit and scope.

All examples and conditional language recited herein are intended for pedagogical purposes to aid the reader in understanding the present principles and the concepts contributed by the inventor(s) to furthering the art, and are to be construed as being without limitation to such specifically recited examples and conditions.

Moreover, all statements herein reciting principles, aspects, and embodiments of the present principles, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the present principles. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The present principles as defined by such claims reside in the fact that the functionalities provided by the various recited means are combined and brought together in the manner which the claims call for. It is thus regarded that any means that can provide those functionalities are equivalent to those shown herein.

Reference in the specification to “one embodiment” or “an embodiment” of the present principles means that a particular feature, structure, characteristic, and so forth described in connection with the embodiment is included in at least one embodiment of the present principles. Thus, the appearances of the phrase “in one embodiment” or “in an embodiment” appearing in various places throughout the specification are not necessarily all referring to the same embodiment.

It is to be appreciated that the use of the term “and/or”, for example, in the case of “A and/or B”, is intended to encompass the selection of the first listed option (A), the selection of the second listed option (B), or the selection of both options (A and B). As a further example, in the case of “A, B, and/or C”, such phrasing is intended to encompass the selection of the first listed option (A), the selection of the second listed option (B), the selection of the third listed option (C), the selection of the first and the second listed options (A and B), the selection of the first and third listed options (A and C), the selection of the second and third listed options (B and C), or the selection of all three options (A and B and C). This may be extended, as readily apparent by one of ordinary skill in this and related arts, for as many items listed.

Further, it is to be appreciated that while one or more embodiments of the present principles are described herein with respect to the MPEG-4 AVC standard, the present principles are not limited to solely this standard and, thus, may be utilized with respect to other video coding standards, recommendations, and extensions thereof, including extensions of the MPEG-4 AVC standard, while maintaining the spirit of the present principles.

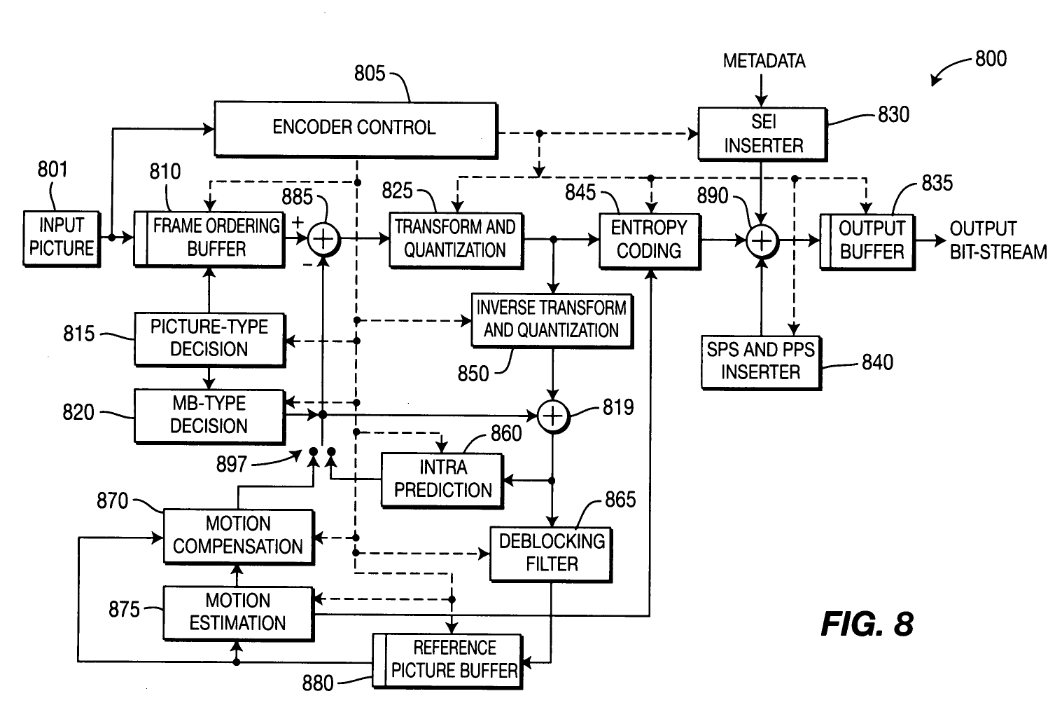

Turning to FIG. 8, an exemplary video encoder to which the present principles may be applied is indicated generally by the reference numeral 800.

The video encoder 800 includes a frame ordering buffer 810 having an output in signal communication with a non-inverting input of a combiner 885. An output of the combiner 885 is connected in signal communication with a first input of a transformer and quantizer 825. An output of the transformer and quantizer 825 is connected in signal communication with a first input of an entropy coder 845 and a first input of an inverse transformer and inverse quantizer 850. An output of the entropy coder 845 is connected in signal communication with a first non-inverting input of a combiner 890. An output of the combiner 890 is connected in signal communication with a first input of an output buffer 835.

A first output of an encoder controller 805 is connected in signal communication with a second input of the frame ordering buffer 810, a second input of the inverse transformer and inverse quantizer 850, an input of a picture-type decision module 815, an input of a macroblock-type (MB-type) decision module 820, a second input of an intra prediction module 860, a second input of a deblocking filter 865, a first input of a motion compensator 870, a first input of a motion estimator 875, and a second input of a reference picture buffer 880.

A second output of the encoder controller 805 is connected in signal communication with a first input of a Supplemental Enhancement Information (SEI) inserter 830, a second input of the transformer and quantizer 825, a second input of the entropy coder 845, a second input of the output buffer 835, and an input of the Sequence Parameter Set (SPS) and Picture Parameter Set (PPS) inserter 840.

A first output of the picture-type decision module 815 is connected in signal communication with a third input of a frame ordering buffer 810. A second output of the picture-type decision module 815 is connected in signal communication with a second input of a macroblock-type decision module 820.

An output of the Sequence Parameter Set (SPS) and Picture Parameter Set (PPS) inserter 840 is connected in signal communication with a third non-inverting input of the combiner 890.

An output of the inverse quantizer and inverse transformer 850 is connected in signal communication with a first non-inverting input of a combiner 819. An output of the combiner 819 is connected in signal communication with a first input of the intra prediction module 860 and a first input of the deblocking filter 865. An output of the deblocking filter 865 is connected in signal communication with a first input of a reference picture buffer 880. An output of the reference picture buffer 880 is connected in signal communication with a second input of the motion estimator 875. A first output of the motion estimator 875 is connected in signal communication with a second input of the motion compensator 870. A second output of the motion estimator 875 is connected in signal communication with a third input of the entropy coder 845.

An output of the motion compensator 870 is connected in signal communication with a first input of a switch 897. An output of the intra prediction module 860 is connected in signal communication with a second input of the switch 897. An output of the macroblock-type decision module 820 is connected in signal communication with a third input of the switch 897. The third input of the switch 897 determines whether or not the “data” input of the switch (as compared to the control input, i.e., the third input) is to be provided by the motion compensator 870 or the intra prediction module 860. The output of the switch 897 is connected in signal communication with a second non-inverting input of the combiner 819 and with an inverting input of the combiner 885.

Inputs of the frame ordering buffer 810 and the encoder controller 805 are available as input of the encoder 800, for receiving an input picture 801. Moreover, an input of the Supplemental Enhancement Information (SEI) inserter 830 is available as an input of the encoder 800, for receiving metadata. An output of the output buffer 835 is available as an output of the encoder 800, for outputting a bitstream.

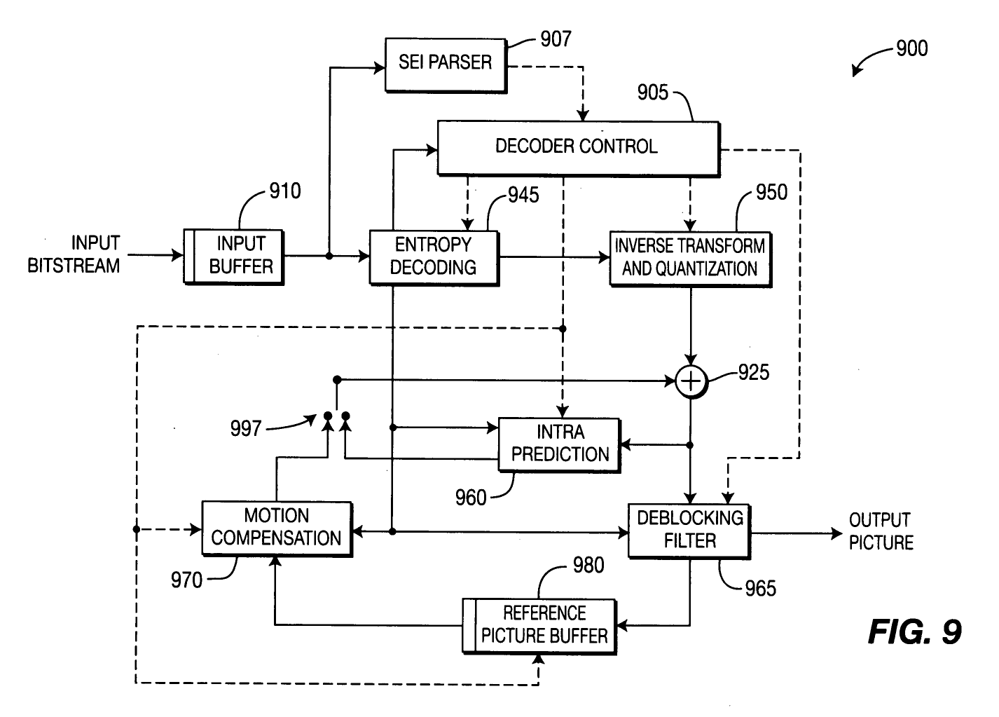

Turning to FIG. 9, an exemplary video decoder to which the present principles may be applied in indicated generally by the reference numeral 900.

The video decoder 900 includes an input buffer 910 having an output connected in signal communication with a first input of the entropy decoder 945 and a first input of a Supplemental Enhancement Information (SEI) parser 907. A first output of the entropy decoder 945 is connected in signal communication with a first input of an inverse transformer and inverse quantizer 950. An output of the inverse transformer and inverse quantizer 950 is connected in signal communication with a second non-inverting input of a combiner 925. An output of the combiner 925 is connected in signal communication with a second input of a deblocking filter 965 and a first input of an intra prediction module 960. A second output of the deblocking filter 965 is connected in signal communication with a first input of a reference picture buffer 980. An output of the reference picture buffer 980 is connected in signal communication with a second input of a motion compensator 970.

A second output of the entropy decoder 945 is connected in signal communication with a third input of the motion compensator 970 and a first input of the deblocking filter 965. A third output of the entropy decoder 945 is connected in signal communication with a first input of a decoder controller 905. An output of the SEI parser 907 is connected in signal communication with a second input of the decoder controller 905. A first output of the decoder controller 905 is connected in signal communication with a second input of the entropy decoder 945. A second output of the decoder controller 905 is connected in signal communication with a second input of the inverse transformer and inverse quantizer 950. A third output of the decoder controller 905 is connected in signal communication with a third input of the deblocking filter 965. A fourth output of the decoder controller 905 is connected in signal communication with a second input of the intra prediction module 960, with a first input of the motion compensator 970, and with a second input of the reference picture buffer 980.

An output of the motion compensator 970 is connected in signal communication with a first input of a switch 997. An output of the intra prediction module 960 is connected in signal communication with a second input of the switch 997. An output of the switch 997 is connected in signal communication with a first non-inverting input of the combiner 925.

An input of the input buffer 910 is available as an input of the decoder 900, for receiving an input bitstream. A first output of the deblocking filter 965 is available as an output of the decoder 900, for outputting an output picture.

As noted above, the present principles are directed to methods and apparatus for video stream splicing. The present principles are primarily described with respect to the stream splicing with respect to one or more streams compliant with the MPEG-4 AVC Standard. However, it is to be appreciated that the present principles are not limited to the streams compliant with the MPEG-4 AVC Standard, and may be utilized with other video coding standards and recommendations having similar problems as that of the prior art stream splicing involving the MPEG-4 AVC Standard, while maintaining the spirit of the present principles.

Hypothetical reference decoder (HRD) conformance is a normative part of the MPEG-4 AVC standard. A major problem in stream splicing involving the MPEG-4 AVC Standard is that there is no guarantee that the stream spliced with independently HRD-compliant source streams is still HRD-compliant.

Accordingly, the present principles provide methods and apparatus able to create a spliced stream while ensuring the spliced stream is compliant with the MPEG-4 AVC Standard. Methods and apparatus in accordance with the present principles ensure that a stream created by hypothetical reference decoder (HRD) compliant source streams is still HRD compliant. In one or more embodiments, this is done by changing hypothetical reference decoder parameters placed in the buffering period supplemental enhancement information (SEI) message and picture timing supplemental enhancement information message, and/or by modifying the hypothetical reference decoder behavior specified in the MPEG-4 AVC Standard, to support the stream splicing.

Definitions will now be provided with respect to various terms used herein.

In-point: The access unit immediate after the splicing boundary. An in-point has to be an IDR picture and there must be a buffering period SEI message associated with it.
Out-point: The access unit immediate before the splicing boundary.
Splice type: There are two types of splicing, namely seamless splicing and non-seamless splicing. Seamless splicing allows clean instantaneous switching of streams. The video stream to be spliced is created to have matching hypothetical reference decoder buffer characteristics at the splice. The time between when the old streams end and the last old picture is decoded is to be exactly one frame less than the startup delay of the new stream. Non-seamless splicing avoids decoder buffer overflow by inserting short dead time between two streams. This assures that new stream begins with an empty buffer. The splicing device waits before inserting the new stream to assure that the decoder's buffer is empty, thus avoiding the chance of overflow. The decoder's picture should freeze during the startup delay of the new stream.

A method for video stream splicing in accordance with present principles will now be described.

In accordance with the method, the new hypothetical reference decoder described below can simplify the stream splicing operation.

Compared with the hypothetical reference decoder in the current version of the MPEG-4 AVC Standard, the hypothetical reference decoder described herein includes/involves the following: adding a new syntax element to indicate the position of concatenation; a new rule of deriving the time of removal from the coded picture buffer (CPB) of the first access unit of the new stream based on the type of splicing (i.e., seamless or non-seamless splicing); and a new rule of deriving the decoded picture buffer (DPB) output time in the spliced stream.

A parameter indicating the position of in-point and used to derive the decoding and output timing may be conveyed through high level syntax as part of the stream, for example, in-band or out-of-band).

One example implementation of this syntax element is to add a new type of supplemental enhancement information (SEI) message for splicing. The presence of the splicing supplemental enhancement information (SEI) message indicates the start of a new source stream. The splicing supplemental enhancement information message is added to the in-point access unit by the splicing device.

An embodiment of the above method will now be described.

The syntax of the splicing supplemental enhancement information message is shown in TABLE 1.

TABLE 1

| Splicing ( payloadSize ) { | C | Descripter |
|---|---|---|
| dpb_output_delay_offset | 5 | u(v) |
| } | | |

dpb_output_delay_offset is used to specify the decoded picture buffer output delay in combination with the dpb_output_delay in the picture timing supplemental enhancement information message.

In this embodiment, the dpb_output_delay_offset is explicitly sent.

The disadvantage is that the splicing device needs to parse the source stream in order to derive the value of dpb_output_delay_offset. This adds more workload for the splicing device. Thus, in some circumstances, it may not be the best choice for online or live splicing.

Another embodiment of the above method will now be described.

The Syntax of the splicing supplemental enhancement information message is shown in TABLE 2.

TABLE 2

| Splicing ( payloadSize ) { | C | Descripter |
|---|---|---|
| } | | |

In this embodiment, the dpb_output_delay_offset is not sent, but is derived implicitly.

The advantage is that the splicing device does not need to parse the source stream. The value of dpb_output_delay_offset is derived at the decoder side.

Regarding the above described method, the corresponding behavior of the hypothetical reference decoder will now be described.

Compared to the current hypothetical reference decoder, the hypothetical reference decoder behaviors are changed for the spliced stream, as described below.

The nominal removal time of the picture at in-point is derived. If an access unit is an in-point, the cpb_removal_delay specifies the how many clock ticks to wait after removal from the CPB of the previous access unit before removing from the buffer the access unit associated with the picture timing SEI message.

cpb_removal_delay(nₛ) is derived as follows:

cpb_removal_delay(nₛ)=Max(NumClockTS,Floor(initial_cpb_removal_delay[SchedSelldx].*90000)+t_{af}(nₛ−1)−t_{r,n}(nₛ−1) (1)

where nₛ is the in-point.

This derivation guarantees that the equation (C-15) or (C-16) will not be violated.

Note that if cpb_removal_delay(nₛ)=NumClockTS, then the concatenation is seamless and otherwise, it is non-seamless.

The decoded picture buffer output time is derived from the splicing supplemental enhancement information message.

In a spliced stream, the decoded picture buffer output time of an access unit is derived as follows:

t_{o,dpb}(n)=tᵣ(n)+t_{c}*(dpb_output_delay(n)+dpb_output_delay_offset(nₛ)) (2)

where nₛ is the nearest previous in-point.

If the first embodiment of the above method is applied, then the dpb_output_delay_offset is conveyed by the syntax element in the supplemental enhancement information message.

The dpb_output_delay_offset is derived by the splicing device as follows:

dpb_output_delay_offset(nₛ)=max_initial_delay−dpb_output_delay(nₛ) (3)

where max_initial_delay is no less than the maximum of the dpb_output_delay of all the in-points.

If the second embodiment of the above method is applied, then the dpb_output_delay_offset is derived as follows: initialize max_initial_delay to 0; at each in-point, if max_initial_delay<dpb_output_delay, max_initial_delay=dpb_output_delay; dpb_output_delay_offset (nₛ)=max_initial_delay−dpb_output_delay (nₛ).

Note that if max_initial_delay is initialized with a value no less than the maximum of the dpb_output_delay of all the in-points, then the splicing is seamless.

Thus, according to the current hypothetical reference decoder, there is no guarantee the spliced stream is still going to be HRD compliant.

This is because of the following: the semantics of cpb_removal_delay in the current standard is not compatible with the splicing of independent coded source stream; the mismatched initial decoded picture buffer output delay in the different source streams will cause incorrect output timing; and the initial_cpb_removal_delay will cause a violation of equation C-15/C-16.

According to the present principles, we modify the current hypothetical reference decoder to support video splicing. A solution is proposed to ensure the hypothetical reference decoder conformance of the spliced stream by adding a new supplemental enhancement information message at the splicing point. The problems caused by current hypothetical reference decoder can be solved and the stream splicing operation is simplified.

Another method for video stream splicing in accordance with present principles will now be described.

The problems caused by cpb_removal_delay and dpb_output_delay can be solved by recalculating the cpb_removal_delay and cpb_removal_delay for the final spliced stream and changing the buffering period supplemental enhancement information message and the picture timing supplemental enhancement information message accordingly after the spliced stream is created.

However, this method requires replacing/changing the buffering period supplemental enhancement information message at the beginning of every source stream and almost all the picture timing supplemental enhancement information message which, in turn, requires the splicing device to parse all of the picture. The method requires higher complexity in the splicing device and may not be suitable for real time video splicing application.

Any solution directed to the problem caused by initial_cpb_removal_delay will not work by merely changing the value of initial_cpb_removal_delay in the buffering period supplemental enhancement information message to satisfy the condition imposed in Equations C-15/C-16. Reducing the initial_cpb_removal_delay may cause buffer underflow and a delay of the final arrival time of the following pictures which may turn into new violations of Equations C-15/C-16 in the following buffering periods.

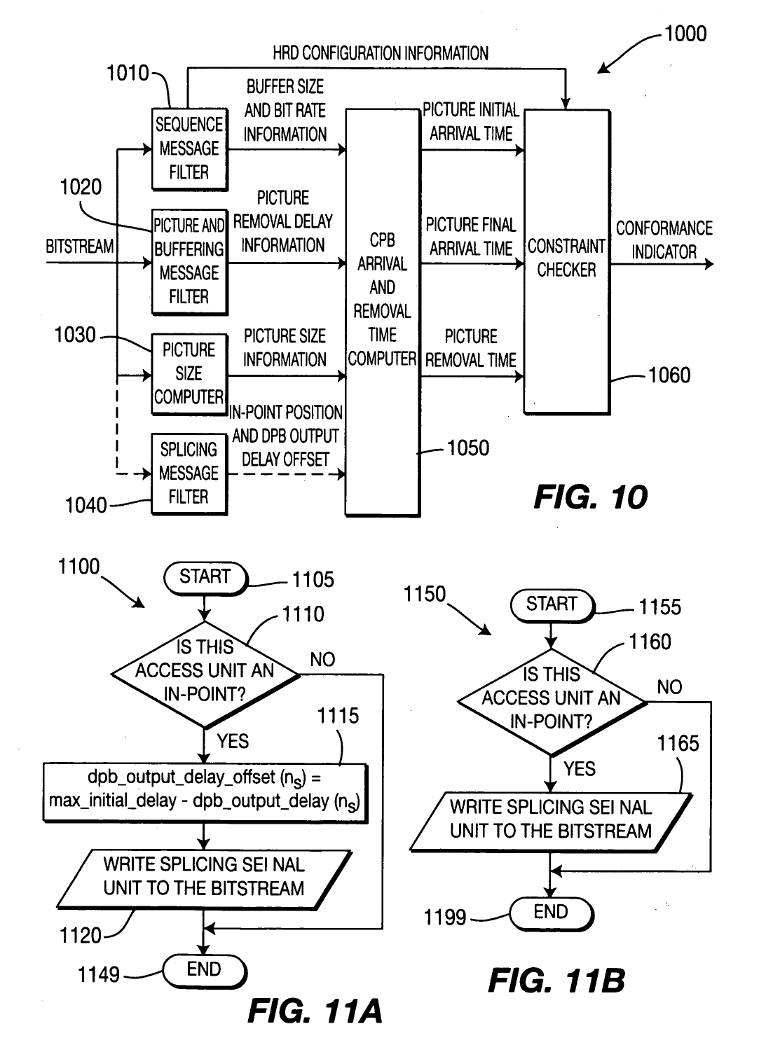

Turning to FIG. 10, an exemplary HRD conformance verifier corresponding to the first method is indicated generally by the reference numeral 1000.

The HRD conformance verifier 1000 includes a sequence message filter 1010 having a first output connected in signal communication with a first input of a CPB arrival and removal time computer 1050. An output of a picture and buffering message filter 1020 is connected in signal communication with a second input of the CPB arrival and removal time computer 1050. An output of a picture size computer 1030 is connected in signal communication with a third input of the CPB arrival and removal time computer 1050. An output of a splicing message filter 1040 is connected in signal communication with a fourth input of the CPB arrival and removal time computer 1050.

A first output of the CPB arrival and removal time computer 1050 is connected in signal communication with a first input of a constraint checker 1060. A second output of the CPB arrival and removal time computer 1050 is connected in signal communication with a second input of the constraint checker 1060. A third output of the CPB arrival and removal time computer 1050 is connected in signal communication with a third input of the constraint checker 1060.

A second output of the sequence message filter 1010 is connected in signal communication with a fourth input of the constraint checker 1060.

Respective inputs of the sequence message filter 1010, the picture and buffering message filter 1020, the picture size computer 1030, and the splicing message filter 1040 are available as inputs to the HRD conformance verifier 1000, for receiving an input bitstream.

An output of the conformance checker 1060 is available as an output of the HRD conformance verifier 1000, for outputting a conformance indicator.

Turning to FIG. 11A, an exemplary method for inserting a splicing Supplemental Enhancement Information (SEI) message is indicated generally by the reference numeral 1100.

The method 1100 includes a start block 1105 that passes control to a decision block 1110. The decision block 1110 determines whether or not this access point is an in-point. If so, the control is passed to a function block 1115. Otherwise, control is passed to an end block 1149.

The function block 1115 sets dpb_output_delay_offset(nₛ) equal to (max_initial_delay−dpb_output_delay(nₛ)), and passes control to a function block 1120. The function block 1120 writes a splicing Supplemental Enhancement Information (SEI) network abstraction layer (NAL) unit to the bitstream, and passes control to an end block 1149.

Turning to FIG. 11B, another exemplary method for inserting a splicing Supplemental Enhancement Information (SEI) message is indicated generally by the reference numeral 1150.

The method 1150 includes a start block 1155 that passes control to a decision block 1160. The decision block 1160 determines whether or not this access point is an in-point. If so, the control is passed to a function block 1165. Otherwise, control is passed to an end block 1199.

The function block 1165 writes a splicing Supplemental Enhancement Information (SEI) network abstraction layer (NAL) unit to the bitstream, and passes control to an end block 1199.

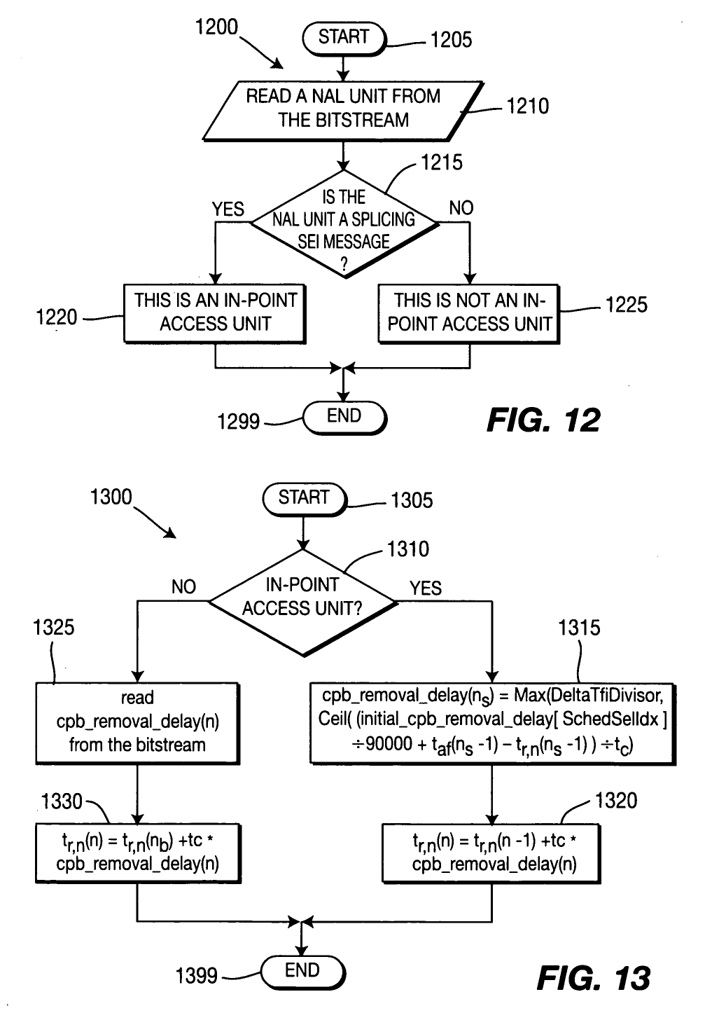

Turning to FIG. 12, an exemplary method for decoding a splicing Supplemental Enhancement Information (SEI) message is indicated generally by the reference numeral 1200.

The method 1200 includes a start block 1205 that passes control to a function block 1210. The function block 1210 reads a network abstraction layer (NAL) unit from the bitstream, and passes control to a decision block 1215. The decision block 1215 determines whether or not the NAL unit is a Splicing Supplemental Enhancement Information (SEI) message. If so, the control is passed to a function block 1220. Otherwise, control is passed to a function block 1225.

The function block 1220 designates the access point as an in-point access point, and passes control to an end block 1299.

The function block 1225 designates the access point as not an in-point access point, and passes control to the end block 1299.

Turning to FIG. 13, an exemplary method for deriving the normal removal time t_{r,n}(n) is indicated generally by the reference numeral 1300.

The method 1300 includes a start block 1305 that passes control to a decision block 1310. The decision block 1310 determines whether or not the current access unit is an in-point access unit. If so, then control is passed to a function block 1315. Otherwise, control is passed to a function block 1325.

The function block 1315 sets cpb_removal_delay(nₛ) equal to Max(DeltaTfiDivisor, Ceil((initial_cpb_removal_delay[SchedSelldx].*90000)+t_{af}(nₛ−1)−t_{r,n}(nₛ−1)).*t_{c}), and passes control to a function block 1320. The function block 1320 sets t_{r,n}(n) equal to t_{r,n}(n−1)+t_{c} cpb_removal_delay(n), and passes control to an end block 1399.

The function block 1325 reads cpb_removal_delay(n) from the bitstream, and passes control to a function block 1330. The function block 1330 sets t_{r,n}(n) equal to t_{r,n}(nₛ)+t_{c}*cpb_removal_delay(n), and passes control to the end block 1399.

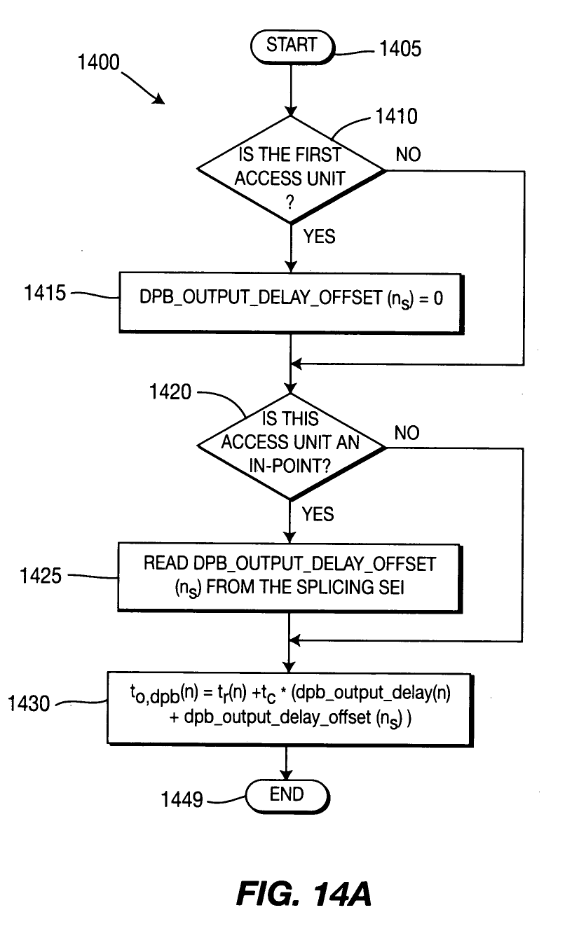

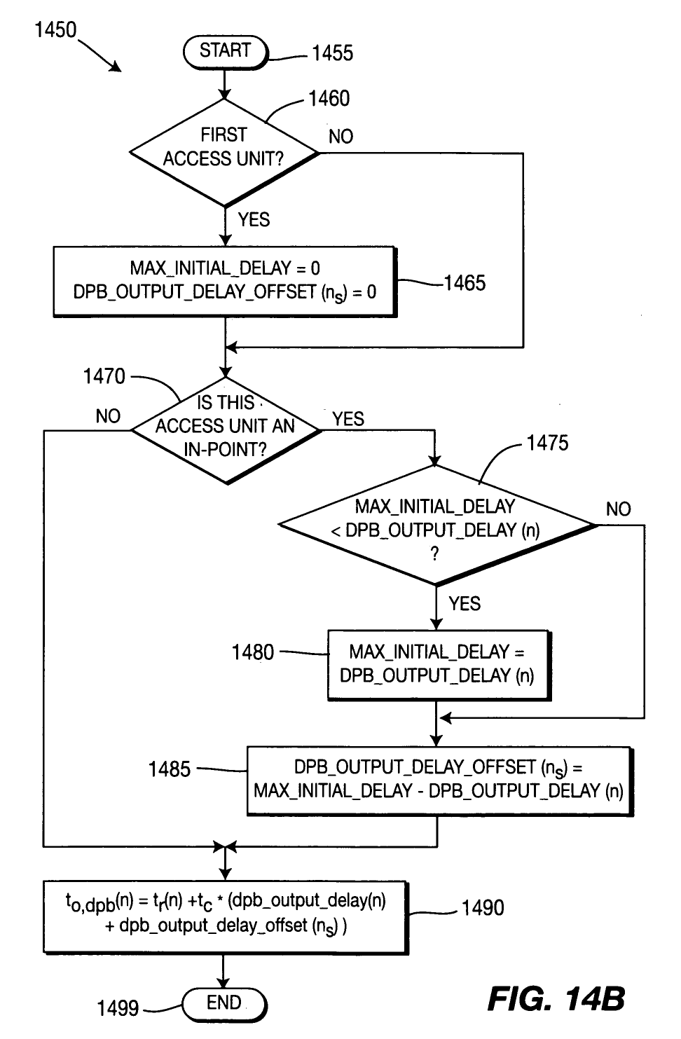

Turning to FIG. 14A, an exemplary method for deriving the decoded picture buffer (DPB) output time t_{o,dpb}(n) is indicated generally by the reference numeral 1400.

The method 1400 includes a start block 1405 that passes control to a decision block 1410. The decision block 1410 determines whether or not the current access unit is the first access unit. If so, then control is passed to a function block 1415. Otherwise, control is passed to a decision block 1420.

The function block 1415 sets dpb_output_delay_offset (nₛ) equal to 0, and passes control to the decision block 1420. The decision block 1420 determines whether or not the current access point is an in-point access point. If so, the control is passed to a function block 1425. Otherwise, control is passed to a function block 1430.

The function block 1425 read dpb_output_delay_offset (nₛ) from the splicing Supplemental Enhancement Information (SEI), and passes control to the function block 1430.

The function block 1430 sets t_{o,dpb}(n) equal to tᵣ(n)+t_{c}*(dpb_output_delay(n)+dpb_output_delay_offset (nₛ)), and passes control to an end block 1449.

Turning to FIG. 14B, another exemplary method for deriving the decoded picture buffer (DPB) output time t_{o,dpb}(n) is indicated generally by the reference numeral 1450.

The method 1450 includes a start block 1455 that passes control to a decision block 1460. The decision block 1460 determines whether or not the current access unit is the first access unit. If so, then control is passed to a function block 1465. Otherwise, control is passed to a decision block 1470.

The function block 1465 sets max_initial_delay equal to 0, dpb_output_delay_offset (nₛ) equal to 0, and passes control to the decision block 1470.

The decision block 1470 determines whether or not the current access unit is an in-point access unit. If so, then control is passed to a decision block 1475. Otherwise, control is passed to a function block 1490.

The decision block 1475 determines whether or not max_initial_delay is less than dpb_output_delay (n). If so, then control is passed to a function block 1480. Otherwise, control is passed to a function block 1485.

The function block 1480 sets max_initial_delay equal to dpb_output_delay (n), and passes control to the function block 1485.

The function block 1485 sets dpb_output_delay_offset (nₛ) equal to max_initial_delay−dpb_output_delay (n), and passes control to the function block 1490. The function block 1490 sets t_{o,dpb}(n)=tᵣ(n)+t_{c}*(dpb_output_delay(n)+dpb_output_delay_offset (nₛ)), and passes control to an end block 1499.

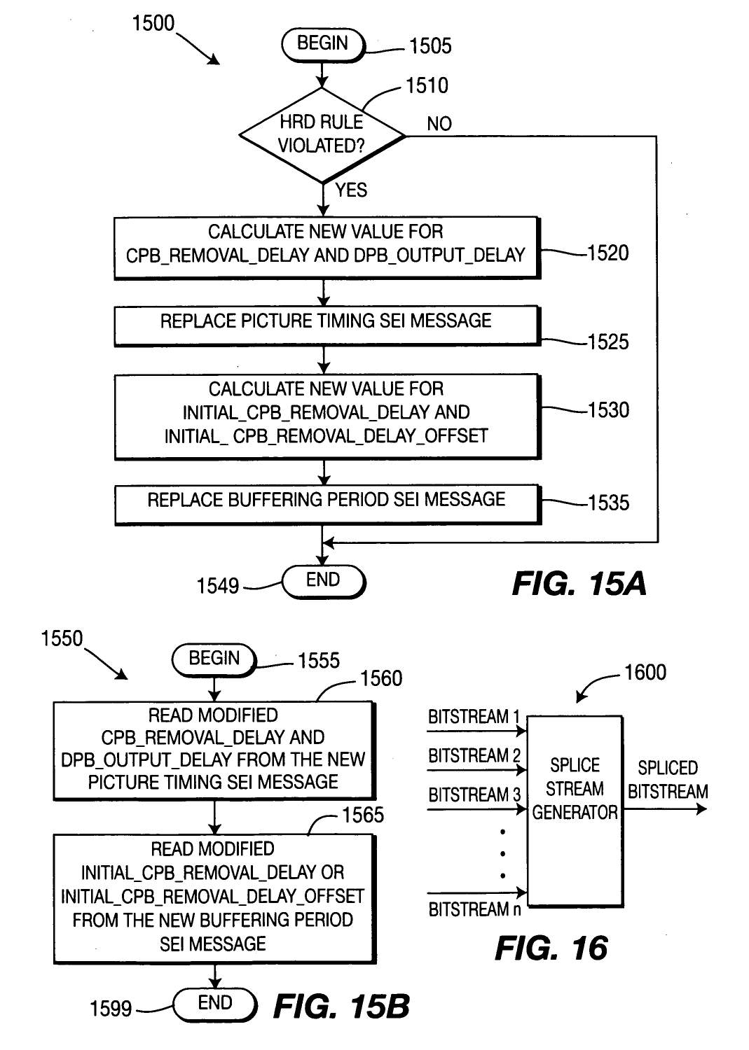

Turning to FIG. 15A, an exemplary method for inserting a Supplemental Enhancement Information (SEI) message is indicated generally by the reference numeral 1500.

The method 1500 includes a start block 1505 that passes control to a decision block 1510. The decision block 1510 determines whether or not any HRD rule has been violated. If so, then control is passed to a function block 1520. Otherwise, control is passed to an end block 1549.

The function block 1520 calculates a new value for cpb_removal_delay and dpb_output_delay, and passes control to a function block 1525. The function block 1525 replaces the picture timing SEI message, and passes control to a function block 1530. The function block 1530 calculates a new value for initial_cpb_removal_delay and initial_cpb_removal_delay_offset, and passes control to a function block 1535. The function block 1535 replaces the buffering period SEI message, and passes control to the end block 1549.

Turning to FIG. 15B, an exemplary method for decoding a Supplemental Enhancement Information (SEI) message is indicated generally by the reference numeral 1550.

The method 1550 includes a start block 1555 that passes control to a function block 1560. The function block 1560 reads a modified cpb_removal_delay and dpb_output_delay from the new picture timing SEI message, and passes control to a function block 1565. The function block 1565 reads a modified initial_cpb_removal_delay or initial_cpb_removal_delay_offset from the new buffering period SEI message, and passes control to an end block 1599.

Turning to FIG. 16, an exemplary splice stream generator is indicated generally by the reference numeral 1600. The splice stream generator 1600 has inputs 1 though n, for receiving bitstream 1 through bitstream n. The splice stream generator 1600 has an output, for outputting a spliced bitstream.

Each input bitstream (1 through n) corresponds to an output bitstream of an encoder, such as the encoder 800 of FIG. 8. The output bitstream provided by the splice stream generator 1600 is input to an HRD verifier, such as HRD conformance verifier 1000 of FIG. 10, for compliancy checking, and/or is input to a decoder, such as decoder 900 of FIG. 9.

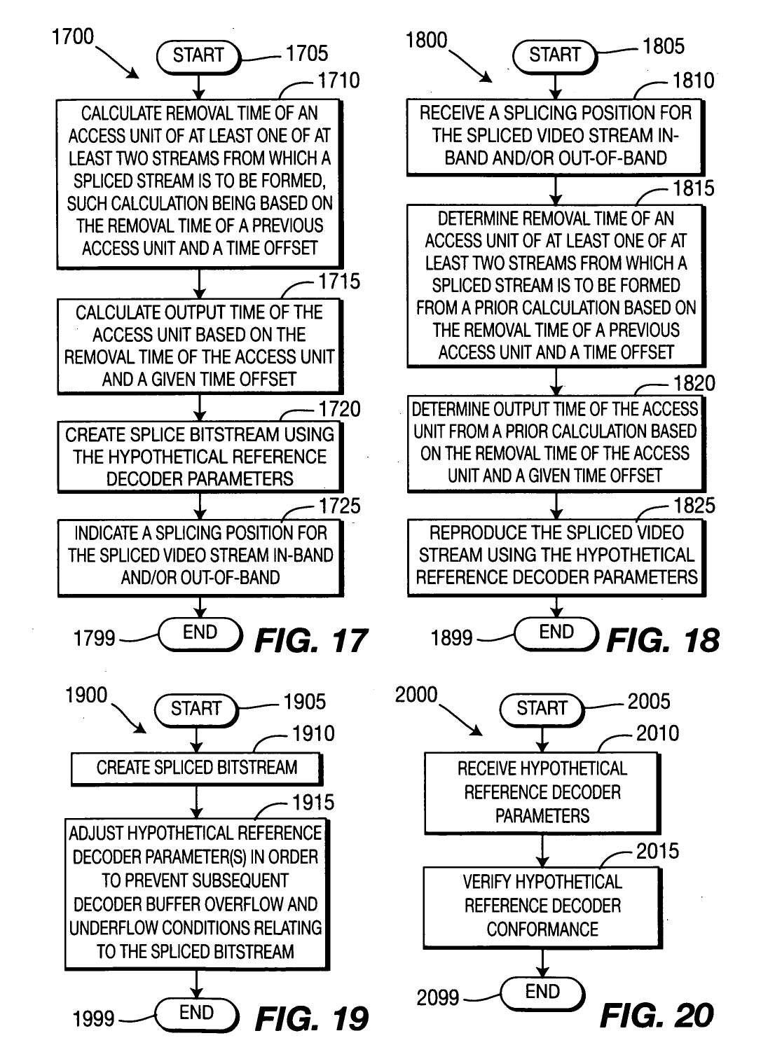

Turning to FIG. 17, an exemplary method for creating a spliced video stream is indicated generally by the reference numeral 1700.

The method 1700 includes a start block 1705 that passes control to a function block 1710. The function block 1710 calculates the removal time of an access unit of at least one of at least two streams from which a spliced stream is to be formed, such calculation being based on the removal time of a previous access unit and a time offset, and passes control to a function block 1715. The time offset may be conveyed in a cpb_removal_delay field in a picture timing SEI message, and/or may be calculated at a corresponding decoder that decodes the spliced video stream.

The function block 1715 calculates the output time of the access unit based on the removal time of the access unit and a given time offset, and passes control to a function block 1720. The given time offset may be equal to the sum of a dpb_output_delay syntax element and another time offset, and/or may be calculated at a corresponding decoder that decodes the spliced video stream. The other time offset may be equal to a difference between a max_initial_delay syntax element and the dpb_output_delay syntax element, may be conveyed in a SEI message, and/or may be calculated at a corresponding decoder that decodes the spliced video stream.

The function block 1720 creates a spliced video stream using the hypothetical reference decoder parameters, such as those calculated by function blocks 1710 and 1715, and passes control to a function block 1725.

The function block 1725 indicates a splicing position for the spliced video stream in-band and/or out-of-band, and passes control to an end block 1799.

Turning to FIG. 18, an exemplary method for reproducing a spliced video stream using hypothetical reference decoder parameters is indicated generally by the reference numeral 1800.

The method 1800 includes a start block 1805 that passes control to a function block 1810. The function block 1810 receives a splicing position for the spliced video stream in-band and/or out-of-band, and passes control to a function block 1815.

The function block 1815 determines the removal time of an access unit of at least one of at least two streams from which a spliced stream is to be formed from a prior calculation based on the removal time of a previous access unit and a time offset, and passes control to a function block 1820. The time offset may be determined from a cpb_removal_delay field in a picture timing SEI message, and/or may be calculated at a corresponding decoder that decodes the spliced video stream.

The function block 1820 determines the output time of the access unit from a prior calculation based on the removal time of the access unit and a given time offset, and passes control to a function block 1825. The given time offset may be equal to the sum of a dpb_output_delay syntax element and another time offset, and/or may be calculated at a corresponding decoder that decodes the spliced video stream. The other time offset may be equal to a difference between a max_initial_delay syntax element and the dpb_output_delay syntax element, may be received in a SEI message, and/or may be calculated at a corresponding decoder that decodes the spliced video stream.

The function block 1825 reproduces the spliced video stream using the hypothetical reference decoder parameters, such as those determined and/or otherwise obtained by function blocks 1815 and 1820, and passes control to an end block 1899.

Turning to FIG. 19, another exemplary method for creating a spliced video stream is indicated generally by the reference numeral 1900.

The method 1900 includes a start block 1905 that passes control to a function block 1910. The function block 1910 creates a spliced video stream by concatenating separate bitstreams, and passes control to a function block 1915.

The function block 1915 adjusts a hypothetical reference decoder parameter syntax value(s) in the spliced bitstream in order to prevent subsequent decoder buffer overflow and underflow conditions relating to the spliced bitstream, and passes control to an end block 1999.

Turning to FIG. 20, another exemplary method for reproducing a spliced video stream is indicated generally by the reference numeral 2000.

The method 2000 includes a start block 2005 that passes control to a function block 2010. The function block 2010 parses a spliced bitstream and receives hypothetical reference decoder parameters extracted there from, and passes control to a function block 2015.

The function block 2015 verifies the hypothetical reference decoder conformance, and passes control to an end block 1999.

A description will now be given of some of the many attendant advantages/features of the present invention, some of which have been mentioned above. For example, one advantage/feature is an apparatus that includes a spliced video stream generator for creating a spliced video stream using hypothetical reference decoder parameters.

Another advantage/feature is the apparatus having the spliced video stream generator as described above, wherein a splicing position for the spliced video stream is indicated in-band or out-of-band.

Yet another advantage/feature is the apparatus having the spliced video stream generator wherein a splicing position for the spliced video stream is indicated in-band or out-of-band as described above, wherein the splicing position is indicated using a Network Abstraction Layer unit.

Still another advantage/feature is the apparatus having the spliced video stream generator wherein the splicing position is indicated using a Network Abstraction Layer unit as described above, wherein the Network Abstraction Layer unit is a supplemental enhancement information message or an end of stream Network Abstraction Layer unit.

Moreover, another advantage/feature is the apparatus having the spliced video stream generator as described above, wherein a removal time of an access unit of at least one of at least two streams from which the spliced stream is formed is calculated based on a removal time of a previous access unit and a time offset.

Further, another advantage/feature is the apparatus having the spliced video stream generator wherein a removal time of an access unit of at least one of at least two streams from which the spliced stream is formed is calculated based on a removal time of a previous access unit and a time offset as described above, wherein the time offset is conveyed in a cpb_removal_delay field in a picture timing supplemental enhancement information message.

Also, another advantage/feature is the apparatus having the spliced video stream generator as described above, wherein an output time of an access unit of at least one of at least two streams from which the spliced stream is formed is calculated based on a removal time of the access unit and a time offset.

Additionally, another advantage/feature is the apparatus having the spliced video stream generator wherein an output time of an access unit of at least one of at least two streams from which the spliced stream is formed is calculated based on a removal time of the access unit and a time offset as described above, wherein the time offset is calculated at a corresponding decoder that decodes the spliced video stream.

Moreover, another advantage/feature is the apparatus having the spliced video stream generator wherein the time offset is calculated at a corresponding decoder that decodes the spliced video stream as described above, wherein the time offset is equal to a sum of a dpb_output_delay syntax element and another time offset, the dpb_output_delay syntax element being placed in a picture timing supplemental enhancement information message.

Further, another advantage/feature is the apparatus having the spliced video stream generator wherein the time offset is equal to a sum of a dpb_output_delay syntax element and another time offset, the dpb_output_delay syntax element being placed in a picture timing supplemental enhancement information message as described above, wherein the other time offset is calculated at a corresponding decoder that decodes the spliced video stream.

Also, another advantage/feature is the apparatus having the spliced video stream generator wherein the other time offset is calculated at a corresponding decoder that decodes the spliced video stream as described above, wherein the other time offset is equal to a difference between a max_initial_delay syntax element and the dpb_output_delay syntax element.

Additionally, another advantage/feature is the apparatus having the spliced video stream generator wherein the time offset is equal to a sum of a dpb_output_delay syntax element and another time offset, the dpb_output_delay syntax element being placed in a picture timing supplemental enhancement information message as described above, wherein the other time offset is conveyed in a supplemental enhancement information message.

Moreover, another advantage/feature is the apparatus having the spliced video stream generator wherein the other time offset is conveyed in a supplemental enhancement information message as described above, wherein the other time offset is equal to a difference between a max_initial_delay syntax element and the dpb_output_delay syntax element.

Further, another advantage/feature is an apparatus having a spliced video stream generator for creating a spliced video stream that prevents decoder buffer overflow and underflow conditions relating to the spliced video stream by modifying standard values of at least one hypothetical reference decoder related high level syntax element.

Also, another advantage/feature is the apparatus having the spliced video stream generator as described above, wherein the at least one hypothetical reference decoder related high level syntax element includes a cpb_removal_delay syntax element in a picture timing supplemental enhancement information message.

Additionally, another advantage/feature is the apparatus having the spliced video stream generator as described above, wherein the at least one hypothetical reference decoder related high level syntax element includes a dpb_output_delay syntax element in a picture timing supplemental enhancement information message.

Moreover, another advantage/feature is the apparatus having the spliced video stream generator as described above, wherein the at least one hypothetical reference decoder related high level syntax element includes an initial_cpb_removal_delay syntax element in a buffing period supplemental enhancement information message.

Further, another advantage/feature is the apparatus having the spliced video stream generator as described above, wherein the spliced video stream generator (1600) creates bitstreams compliant with the International Organization for Standardization/International Electrotechnical Commission Moving Picture Experts Group-4 Part 10 Advanced Video Coding standard/International Telecommunication Union, Telecommunication Sector H.264 recommendation.

Also, another advantage/feature is an apparatus having a spliced video stream generator for receiving hypothetical reference decoder parameters for a spliced video stream and for reproducing the spliced video stream using the hypothetical reference decoder parameters.

Additionally, another advantage/feature is the apparatus having the spliced video stream generator as described above, wherein a splicing position for the spliced video stream is indicated in-band or out-of-band.

Moreover, another advantage/feature is the apparatus having the spliced video stream generator wherein a splicing position for the spliced video stream is indicated in-band or out-of-band as described above, wherein the splicing position is indicated using a Network Abstraction Layer unit.

Further, another advantage/feature is the apparatus having the spliced video stream generator wherein the splicing position is indicated using a Network Abstraction Layer unit as described above, wherein the Network Abstraction Layer unit is a Supplemental Enhancement Information message or an end of stream Network Abstraction Layer unit.

Also, another advantage/feature is the apparatus having the spliced video stream generator as described above, wherein a removal time of an access unit of at least one of at least two streams from which the spliced stream is formed is calculated based on a removal time of a previous access unit and a time offset.

Additionally, another advantage/feature is the apparatus having the spliced video stream generator wherein a removal time of an access unit of at least one of at least two streams from which the spliced stream is formed is calculated based on a removal time of a previous access unit and a time offset as described above, wherein the time offset is conveyed in a cpb_removal_delay field in a picture timing supplemental enhancement information message.

Moreover, another advantage/feature is the apparatus having the spliced video stream generator wherein the time offset is conveyed in a cpb_removal_delay field in a picture timing supplemental enhancement information message as described above, wherein the time offset is calculated at a corresponding decoder that decodes the spliced video stream.

Further, another advantage/feature is the apparatus having the spliced video stream generator as described above, wherein an output time of an access unit of at least one of at least two streams from which the spliced stream is formed is calculated based on a removal time of the access unit and a time offset.

Also, another advantage/feature is the apparatus having the spliced video stream generator wherein an output time of an access unit of at least one of at least two streams from which the spliced stream is formed is calculated based on a removal time of the access unit and a time offset as described above, wherein the time offset is equal to a sum of a dpb_output_delay syntax element and another time offset, the dpb_output_delay syntax element being placed in a picture timing supplemental enhancement information message.

Additionally, another advantage/feature is the apparatus having the spliced video stream generator wherein the time offset is equal to a sum of a dpb_output_delay syntax element and another time offset, the dpb_output_delay syntax element being placed in a picture timing supplemental enhancement information message as described above, wherein the other time offset is calculated at a corresponding decoder that decodes the spliced video stream.

Moreover, another advantage/feature is the apparatus having the spliced video stream generator wherein the other time offset is calculated at a corresponding decoder that decodes the spliced video stream as described above, wherein the other time offset is equal to a difference between a max_initial_delay syntax element and the dpb_output_delay syntax element.

Further, another advantage/feature is the apparatus having the spliced video stream generator wherein the time offset is equal to a sum of a dpb_output_delay syntax element and another time offset, the dpb_output_delay syntax element being placed in a picture timing supplemental enhancement information message as described above, wherein the other time offset is conveyed in a supplemental enhancement information message.

Also, another advantage/feature is the apparatus having the spliced video stream generator wherein the other time offset is conveyed in a supplemental enhancement information message as described above, wherein the other time offset is equal to a difference between a max_initial_delay syntax element and the dpb_output_delay syntax element.

Additionally, another advantage/feature is an apparatus having a spliced video stream generator for receiving modified standard values of at least one hypothetical reference decoder related high level syntax element corresponding to a spliced video stream and for reproducing the spliced video stream while preventing decoder buffer overflow and underflow conditions relating to the spliced video stream using the modified standard values of at least one hypothetical reference decoder related high level syntax element.

Moreover, another advantage/feature is the apparatus having the spliced video stream generator as described above, wherein the at least one hypothetical reference decoder related high level syntax element includes a cpb_removal_delay syntax element in a picture timing supplemental enhancement information message.

Further, another advantage/feature is the apparatus having the spliced video stream generator as described above, wherein the at least one hypothetical reference decoder related high level syntax element includes a dpb_output_delay syntax element in a picture timing supplemental enhancement information message.

Also, another advantage/feature is the apparatus having the spliced video stream generator as described above, wherein the at least one hypothetical reference decoder related high level syntax element includes an initial_cpb_removal_delay syntax element in a buffing period supplemental enhancement information message.

Additionally, another advantage/feature is the apparatus having the spliced video stream generator as described above, wherein the spliced video stream generator (1600) creates bitstreams compliant with the International Organization for Standardization/International Electrotechnical Commission Moving Picture Experts Group-4 Part 10 Advanced Video Coding standard/International Telecommunication Union, Telecommunication Sector H.264 recommendation.

These and other features and advantages of the present principles may be readily ascertained by one of ordinary skill in the pertinent art based on the teachings herein. It is to be understood that the teachings of the present principles may be implemented in various forms of hardware, software, firmware, special purpose processors, or combinations thereof.

Most preferably, the teachings of the present principles are implemented as a combination of hardware and software. Moreover, the software may be implemented as an application program tangibly embodied on a program storage unit. The application program may be uploaded to, and executed by, a machine comprising any suitable architecture. Preferably, the machine is implemented on a computer platform having hardware such as one or more central processing units (“CPU”), a random access memory (“RAM”), and input/output (“I/O”) interfaces. The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit and a printing unit.

It is to be further understood that, because some of the constituent system components and methods depicted in the accompanying drawings are preferably implemented in software, the actual connections between the system components or the process function blocks may differ depending upon the manner in which the present principles are programmed. Given the teachings herein, one of ordinary skill in the pertinent art will be able to contemplate these and similar implementations or configurations of the present principles.

Although the illustrative embodiments have been described herein with reference to the accompanying drawings, it is to be understood that the present principles is not limited to those precise embodiments, and that various changes and modifications may be effected therein by one of ordinary skill in the pertinent art without departing from the scope or spirit of the present principles. All such changes and modifications are intended to be included within the scope of the present principles as set forth in the appended claims.

1. An apparatus, comprising:
a spliced video stream generator for creating a spliced video stream using hypothetical reference decoder parameters.

2. The apparatus of claim 1, wherein a splicing position for the spliced video stream is indicated in-band or out-of-band.

3. The apparatus of claim 2, wherein the splicing position is indicated using a Network Abstraction Layer unit.

4. The apparatus of claim 3, wherein the Network Abstraction Layer unit is a supplemental enhancement information message or an end of stream Network Abstraction Layer unit.

5. The apparatus of claim 1, wherein a removal time of an access unit of at least one of at least two streams from which the spliced stream is formed is calculated based on a removal time of a previous access unit and a time offset.

6. The apparatus of claim 5, wherein the time offset is conveyed in a cpb_removal_delay field in a picture timing supplemental enhancement information message.

7. The apparatus of claim 1, wherein an output time of an access unit of at least one of at least two streams from which the spliced stream is formed is calculated based on a removal time of the access unit and a time offset.

8. The apparatus of claim 7, wherein the time offset is calculated at a corresponding decoder that decodes the spliced video stream.

9. The apparatus of claim 8, wherein the time offset is equal to a sum of a dpb_output_delay syntax element and another time offset, the dpb_output_delay syntax element being placed in a picture timing supplemental enhancement information message.

10. The apparatus of claim 9, wherein the other time offset is calculated at a corresponding decoder that decodes the spliced video stream.

11. The apparatus of claim 10, wherein the other time offset is equal to a difference between a max_initial_delay syntax element and the dpb_output_delay syntax element.

12. The apparatus of claim 9, wherein the other time offset is conveyed in a supplemental enhancement information message.

13. The apparatus of claim 12, wherein the other time offset is equal to a difference between a max_initial_delay syntax element and the dpb_output_delay syntax element.

14. An apparatus, comprising:
a spliced video stream generator for creating a spliced video stream that prevents decoder buffer overflow and underflow conditions relating to the spliced video stream by modifying standard values of at least one hypothetical reference decoder related high level syntax element.

15. The apparatus of claim 14, wherein the at least one hypothetical reference decoder related high level syntax element includes a cpb_removal_delay syntax element in a picture timing supplemental enhancement information message.

16. The apparatus of claim 14, wherein the at least one hypothetical reference decoder related high level syntax element includes a dpb_output_delay syntax element in a picture timing supplemental enhancement information message.

17. The apparatus of claim 14, wherein the at least one hypothetical reference decoder related high level syntax element includes an initial_cpb_removal_delay syntax element in a buffing period supplemental enhancement information message.

18. The apparatus of claim 14, wherein the spliced video stream generator creates bitstreams compliant with the International Organization for Standardization/International Electrotechnical Commission Moving Picture Experts Group-4 Part 10 Advanced Video Coding standard/International Telecommunication Union, Telecommunication Sector 1-1.264 recommendation.

19. A method, comprising:
creating a spliced video stream using hypothetical reference decoder parameters.

20. The method of claim 19, wherein a splicing position for the spliced video stream is indicated in-band or out-of-band.

21. The method of claim 20, wherein the splicing position is indicated using a Network Abstraction Layer unit.

22. The method of claim 21, wherein the Network Abstraction Layer unit is a Supplemental Enhancement Information message or an end of stream Network Abstraction Layer unit.

23. The method of claim 19, wherein a removal time of an access unit of at least one of at least two streams from which the spliced stream is formed is calculated based on a removal time of a previous access unit and a time offset.

24. The method of claim 23, wherein the time offset is conveyed in a cpb_removal_delay field in a picture timing supplemental enhancement information message.

25. The method of claim 24, wherein the time offset is calculated at a corresponding decoder that decodes the spliced video stream.

26. The method of claim 19, wherein an output time of an access unit of at least one of at least two streams from which the spliced stream is formed is calculated based on a removal time of the access unit and a time offset.

27. The method of claim 26, wherein the time offset is equal to a sum of a dpb_output_delay syntax element and another time offset, the dpb_output_delay syntax element being placed in a picture timing supplemental enhancement information message.

28. The method of claim 27, wherein the other time offset is calculated at a corresponding decoder that decodes the spliced video stream.

29. The method of claim 28, wherein the other time offset is equal to a difference between a max_initial_delay syntax element and the dpb_output_delay syntax element.

30. The method of claim 27, wherein the other time offset is conveyed in a supplemental enhancement information message.

31. The method of claim 30, wherein the other time offset is equal to a difference between a max_initial_delay syntax element and the dpb_output_delay syntax element.

32. A method, comprising:
creating a spliced video stream that prevents decoder buffer overflow and underflow conditions relating to the spliced video stream by modifying standard values of at least one hypothetical reference decoder related high level syntax element.

33. The method of claim 32, wherein the at least one hypothetical reference decoder related high level syntax element includes a cpb_removal_delay syntax element in a picture timing supplemental enhancement information message.

34. The method of claim 32, wherein the at least one hypothetical reference decoder related high level syntax element includes a dpb_output_delay syntax element in a picture timing supplemental enhancement information message.

35. The method of claim 32, wherein the at least one hypothetical reference decoder related high level syntax element includes an initial_cpb_removal_delay syntax element in a buffing period supplemental enhancement information message.

36. The method of claim 32, wherein the spliced bitstream is created to be compliant with the International Organization for Standardization/International Electrotechnical Commission Moving Picture Experts Group-4 Part 10 Advanced Video Coding standard/International Telecommunication Union, Telecommunication Sector H.264 recommendation.

37. An apparatus, comprising:
a spliced video stream generator for receiving hypothetical reference decoder parameters for a spliced video stream and for reproducing the spliced video stream using the hypothetical reference decoder parameters.

38. The apparatus of claim 37, wherein a splicing position for the spliced video stream is indicated in-band or out-of-band.

39. The apparatus of claim 38, wherein the splicing position is indicated using a Network Abstraction Layer unit.

40. The apparatus of claim 39, wherein the Network Abstraction Layer unit is a Supplemental Enhancement Information message or an end of stream Network Abstraction Layer unit.

41. The apparatus of claim 37, wherein a removal time of an access unit of at least one of at least two streams from which the spliced stream is formed is calculated based on a removal time of a previous access unit and a time offset.

42. The apparatus of claim 41, wherein the time offset is conveyed in a cpb_removal_delay field in a picture timing supplemental enhancement information message.

43. The apparatus of claim 42, wherein the time offset is calculated at a corresponding decoder that decodes the spliced video stream.

44. The apparatus of claim 37, wherein an output time of an access unit of at least one of at least two streams from which the spliced stream is formed is calculated based on a removal time of the access unit and a time offset.

45. The apparatus of claim 44, wherein the time offset is equal to a sum of a dpb_output_delay syntax element and another time offset, the dpb_output_delay syntax element being placed in a picture timing supplemental enhancement information message.

46. The apparatus of claim 45, wherein the other time offset is calculated at a corresponding decoder that decodes the spliced video stream.

47. The apparatus of claim 46, wherein the other time offset is equal to a difference between a max_initial_delay syntax element and the dpb_output_delay syntax element.

48. The apparatus of claim 45, wherein the other time offset is conveyed in a supplemental enhancement information message.

49. The apparatus of claim 48, wherein the other time offset is equal to a difference between a max_initial_delay syntax element and the dpb_output_delay syntax element.

50. An apparatus, comprising:
a spliced video stream generator for receiving modified standard values of at least one hypothetical reference decoder related high level syntax element corresponding to a spliced video stream and for reproducing the spliced video stream while preventing decoder buffer overflow and underflow conditions relating to the spliced video stream using the modified standard values of at least one hypothetical reference decoder related high level syntax element.

51. The apparatus of claim 50, wherein the at least one hypothetical reference decoder related high level syntax element includes a cpb_removal_delay syntax element in a picture timing supplemental enhancement information message.

52. The apparatus of claim 50, wherein the at least one hypothetical reference decoder related high level syntax element includes a dpb_output_delay syntax element in a picture timing supplemental enhancement information message.

53. The apparatus of claim 50, wherein the at least one hypothetical reference decoder related high level syntax element includes an initial_cpb_removal_delay syntax element in a buffing period supplemental enhancement information message.

54. The apparatus of claim 50, wherein the spliced video stream generator creates bitstreams compliant with the International Organization for Standardization/International Electrotechnical Commission Moving Picture Experts Group-4 Part 10 Advanced Video Coding standard/International Telecommunication Union, Telecommunication Sector H.264 recommendation.

55. A method, comprising:
receiving hypothetical reference decoder parameters for a spliced video stream; and
reproducing the spliced video stream using the hypothetical reference decoder parameters.

56. The method of claim 55, wherein a splicing position for the spliced video stream is indicated in-band or out-of-band.

57. The method of claim 56, wherein the splicing position is indicated using a Network Abstraction Layer unit.

58. The method of claim 57, wherein the Network Abstraction Layer unit is a Supplemental Enhancement Information message or an end of stream Network Abstraction Layer unit.

59. The method of claim 55, wherein a removal time of an access unit of at least one of at least two streams from which the spliced stream is formed is determined from a prior calculation based on a removal time of a previous access unit and a time offset.

60. The method of claim 59, wherein the time offset is received in a cpb_removal_delay field in a picture timing supplemental enhancement information message.

61. The method of claim 60, wherein the time offset is calculated at a corresponding decoder that decodes the spliced video stream.

62. The method of claim 55, wherein an output time of an access unit of at least one of at least two streams from which the spliced stream is formed is determined from a prior calculation based on a removal time of the access unit and a time offset.

63. The method of claim 62, wherein the time offset is equal to a sum of a dpb_output_delay syntax element and another time offset, the dpb_output_delay syntax element determined from a picture timing supplemental enhancement information message.

64. The method of claim 63, wherein the other time offset is calculated at a corresponding decoder that decodes the spliced video stream.

65. The method of claim 64, wherein the other time offset is equal to a difference between a max_initial_delay syntax element and the dpb_output_delay syntax element.

66. The method of claim 63, wherein the other time offset is determined from a supplemental enhancement information message.

67. The method of claim 66, wherein the other time offset is equal to a difference between a max_initial_delay syntax element and the dpb_output_delay syntax element.

68. A method, comprising:
receiving modified standard values of at least one hypothetical reference decoder related high level syntax element corresponding to a spliced video stream; and
reproducing the spliced video stream while preventing decoder buffer overflow and underflow conditions relating to the spliced video stream using the modified standard values of at least one hypothetical reference decoder related high level syntax element.

69. The method of claim 68, wherein the at least one hypothetical reference decoder related high level syntax element includes a cpb_removal_delay syntax element in a picture timing supplemental enhancement information message.

70. The method of claim 68, wherein the at least one hypothetical reference decoder related high level syntax element includes a dpb_output_delay syntax element in a picture timing supplemental enhancement information message.

71. The method of claim 68, wherein the at least one hypothetical reference decoder related high level syntax element includes an initial_cpb_removal_delay syntax element in a buffing period supplemental enhancement information message.

72. The method of claim 68, wherein the spliced video stream is reproduced to be compliant with the International Organization for Standardization/International Electrotechnical Commission Moving Picture Experts Group-4 Part 10 Advanced Video Coding standard/International Telecommunication Union, Telecommunication Sector H.264 recommendation.

73. A video signal structure for video encoding, comprising:
a spliced video stream that prevents decoder buffer overflow and underflow conditions relating to the spliced video stream, the spliced video stream created by modifying standard values of at least one hypothetical reference decoder related high level syntax element.

74. A storage media having video signal data encoded thereupon, comprising:
a spliced video stream that prevents decoder buffer overflow and underflow conditions relating to the spliced video stream, the spliced video stream created by modifying standard values of at least one hypothetical reference decoder related high level syntax element.

75. A video signal structure for video encoding, comprising:
a spliced video stream created using hypothetical reference decoder parameters.

76. A storage media having video signal data encoded thereupon, comprising:
a spliced video stream created using hypothetical reference decoder parameters.
